(19) United States
(12) Patent Application Publication
(10) Pub. No.: US 2024/0409752 A1
(43) Pub. Date: Dec. 12, 2024

(54) THERMOPLASTIC POLYURETHANE POWDERS AND 3D MOLDING FORMED FROM THE SAME

(71) Applicant: BASF SE, Ludwigshafen am Rhein (DE)

(72) Inventors: Zhi Zhong CAI, Shanghai (CN); Wei Zheng FAN, Shanghai (CN); Yan Sheng LI, Shanghai (CN); Pin Lan CHEN, Shanghai (CN)

(21) Appl. No.: 18/700,739

(22) PCT Filed: Oct. 7, 2022
(86) PCT No.: PCT/EP2022/077930

§ 371 Date: Apr. 12, 2024

(30) Foreign Application Priority Data
Oct. 15, 2021 (WO) PCT/CN2021/124151

(51) Int. Cl. C09D 5/03; B29B 17/04; B29C 64/153; B29K 75/00; B29K 105/00; B33Y 10/00; B33Y 70/00; C09D 175/04

(52) U.S. Cl. CPC C09D 5/031; B33Y 70/00; C09D 175/04; B29B 17/0404; B29C 64/153; B29K 2075/00; B29K 2105/251; B29K 2995/0063; B29K 2995/007; B29K 2995/0077; B29K 2995/0094; B33Y 10/00

(57) ABSTRACT

This disclosure relates to thermoplastic polyurethane (TPU) powders derived from expanded TPU and/or molding part thereof, wherein the average particle size D50 of the powders is no more than 1 mm, to a 3D molding formed from the same and to a process of forming the 3D molding. The TPU powders of the present invention can be used to prepare 3D products with low density, high rebound resilience and good mechanical properties, and the TPU powders of the present invention can be derived from a wide range of sources, and the TPU powders and 3D products of the present invention can be easily reused.

### TECHNOLOGY FIELD

The present invention relates to thermoplastic polyurethane powders, 3D molding formed from the same as well as a process of forming the 3D molding.

### BACKGROUND

3D-printing technologies using thermoplastic powders, e.g. selective laser sintering (SLS), multi jet fusion (MJF) and selective heat sintering (SHS), have been used for rapid prototyping and rapid manufacturing processes. Thermoplastic polyurethane powders are a class of 3D printable materials which has been widely used for footwear, protector and consumer applications. To obtain light-weighted 3D printed parts, it is necessary for expanding 3D printed parts from prototyping for end-use parts, especially in automotive and footwear industries. However, it is difficult to obtain 3D printed parts with lower density, high rebound resilience and good mechanical properties. Therefore, there is a strong need to develop a class of material to enable successful 3D printing process, meanwhile with low density, high rebound and good performance.

### SUMMARY OF THE INVENTION

One object of the invention is to provide thermoplastic polyurethane (TPU) powders derived from expanded TPU and/or molding part thereof, wherein the TPU powders of the present invention can be used to prepare 3D products with low density and high rebound resilience.

Another object of the present invention is to provide a powder composition comprising the TPU powders of the present invention and at least one auxiliary agent.

A further object of the present invention is to provide a process for preparing the 3D molding, which comprises using the TPU powders of the present invention.

A further object of the present invention is to provide a 3D molding formed from the TPU powders of the present invention.

It has been surprisingly found that the above objects can be achieved by following embodiments:
1. Thermoplastic polyurethane (TPU) powders derived from expanded TPU and/or molding part thereof, wherein the average particle size D50 of the powders is no more than 1 mm.
2. The TPU powders according to item 1, wherein the average particle size D50 of the TPU powders is in the range from 1 μm to 1 mm.
3. The TPU powders according to item 1 or 2, wherein the average particle size D50 of the TPU powders is in the range from 5 to 800 μm, preferably from 10 to 500 μm.
4. The TPU powders according to any of items 1 to 3, wherein the bulk density of the TPU powders is no more than 1 g/cm³, preferably no more than 0.8 g/cm³, or no more than 0.6 g/cm³.
5. The TPU powders according to any of items 1 to 4, wherein the TPU powders are derived from expanded TPU pellets or molding part thereof or leftover expanded TPU or recycled expanded TPU, or mixture thereof.
6. Use of expanded TPU and/or molding part thereof for manufacturing the TPU powders according to any of items 1 to 5.
7. A process of preparing the TPU powders according to any of items 1 to 5, which comprises pulverizing expanded TPU and/or molding part thereof.
8. A powder composition comprising the TPU powders according to any of items 1 to 5 and at least one auxiliary agent, preferably selected from filler, flowing agent and pigment.
9. Use of the TPU powders according to any one of items 1 to 5 or the powder composition according to item 8 for preparing the 3D molding.
10. A process for preparing the 3D molding, which comprises using the TPU powders according to any of items 1 to 5 or the composition according to item 8.
11. The process according to item 10, wherein the process comprises:
a) adding the TPU powders according to any of items 1 to 5 or the composition according to item 8 to a molding mixture, and
b) producing the molding by selectively bonding the powders.
12. The process according to item 11, wherein the molding produced in step b) is produced by a process for the layer-by-layer build-up of three-dimensional objects by selectively bonding portions of a powder to on another.
13. The process according to item 11 or 12, wherein the selectively bonding comprises selective laser sintering, selective inhibition of the bonding of powders, multi jet fusion, high speed sintering, 3D printing, or a microwave process.
14. A 3D molding formed from the TPU powders according to any of items 1 to 5 or the composition according to item 8.
15. The 3D molding according to item 14, wherein the 3D molding includes sole, outerwear, cloth, footwear, toy, mat, tire, hose, gloves and seals.
16. The 3D molding according to any of item 14 or 15, wherein the density of the 3D molding is no more than 1 g/cm³, preferably no more than 0.95 g/cm³, more preferably no more than 0.9 g/cm³.
17. The 3D molding according to any of item 14 to 16, wherein the rebound resilience according to ASTM D2632 of the 3D molding is at least 35%, preferably at least 40%, more preferably at least 42%.
18. The 3D molding according to any of item 14 to 17, wherein the elongation at break according to ISO527-21/A15 2012 of the 3D molding is at least 50%, preferably at least 80%, more preferably at least 100% or at least 120%.

The TPU powders of the present invention can be used to prepare 3D products with low density, high rebound resilience and good mechanical properties, and the TPU powders of the present invention can be derived from a wide range of sources, especially from the recycled and leftover expanded TPU, and the TPU powders and 3D products of the present invention can be easily reused.

### DESCRIPTION OF THE DRAWING

FIG. 1 shows the picture of printed parts of example C.

FIG. 2 shows the picture of leftover expanded TPU molding parts.

### EMBODIMENT OF THE INVENTION

The undefined article “a”, “an”, “the” means one or more of the species designated by the term following said article.

In the context of the present disclosure, any specific values mentioned for a feature (comprising the specific values mentioned in a range as the end point) can be recombined to form a new range.

One aspect of the present invention is directed to thermoplastic polyurethane (TPU) powders derived from expanded TPU, wherein the average particle size D50 of the powders is no more than 1 mm.

### TPU Powders

According to the present invention, the average particle size D50 of the TPU powders can be in the range from 1 μm to 1 mm, for example 1 μm, 5 μm, 10 μm, 20 μm, 50 μm, 80 μm, 100 μm, 150 μm, 200 μm, 250 μm, 300 μm, 350 μm, 400 μm, 500 μm, 600 μm, 700 μm, 800 μm, 900 μm or 1 mm, preferably from 1 to 800 μm, from 5 to 600 μm, from 10 to 500 μm, from 10 to 400 μm, from 10 to 250 μm, or from 20 to 800 μm, from 20 to 600 μm, from 20 to 400 μm, from 20 to 250 μm, or from 30 to 800 μm, from 30 to 600 μm, from 30 to 400 μm, from 30 to 250 μm, or from 40 to 800 μm, from 40 to 600 μm, from 40 to 400 μm, from 40 to 250 μm, or from 50 to 800 μm, from 50 to 600 μm, from 50 to 400 μm, or from 50 to 250 μm.

The average particle size D50 can be tested according to ISO 13320-1.

In an embodiment, the bulk density of the TPU powders is no more than 1 g/cm³, for example 0.01 g/cm³, 0.05 g/cm³, 0.1 g/cm³, 0.15 g/cm³, 0.2 g/cm³, 0.3 g/cm³, 0.4 g/cm³, 0.5 g/cm³, 0.6 g/cm³, 0.7 g/cm³, 0.8 g/cm³, 0.9 g/cm³, or 1 g/cm³, preferably no more than 0.8 g/cm³, or no more than 0.6 g/cm³, or no more than 0.5 g/cm³. In an embodiment, the bulk density of the TPU powders can be in the range from 0.01 g/cm³ to 1 g/cm³, from 0.05 g/cm³ to 0.9 g/cm³, from 0.05 g/cm³ to 0.7 g/cm³, from 0.05 g/cm³ to 0.65 g/cm³ or from 0.1 g/cm³ to 0.6 g/cm³.

The bulk density of the TPU powders can be tested according to ISO1068.

According to the present invention, the TPU powders are derived from the expanded TPU and/or molding part thereof. The expanded TPU and molding part thereof can have a wide range of sources. For example, these can be selected from the expanded TPU pellets (for example microspheres), molding parts of the expanded TPU (for example molding parts of expanded TPU pellets), leftover expanded TPU, recycled expanded TPU or mixture thereof.

According to an embodiment, the TPU powders of the present invention are derived from, especially are produced by pulverizing (for example grinding) the expanded TPU and/or molding part thereof, for example the expanded TPU pellets (for example microspheres), leftover expanded TPU, recycled expanded TPU, molding parts of expanded TPU or mixture thereof.

TPUs and processes for their production are well known. By way of example, TPUs can be produced via reaction of (a) isocyanates with (b) compounds reactive toward isocyanates and having a molar mass of from 500 to 10000 and, if appropriate, (c) chain extenders having a molar mass of from 50 to 499, if appropriate in the presence of (d) catalysts and/or of (e) conventional auxiliaries and/or conventional additives.

The components (a) isocyanate, (b) compounds which are reactive toward isocyanates, (c) chain extenders are referred to individually or collectively as formative components. The formative components including the catalyst and/or the customary auxiliaries and/or additives are also referred to as starting materials.

According to the invention, preference is given to preparing TPU in which the TPU has a weight average molecular weight of at least 0.1×10⁶ g/mol, preferably at least 0.4×10⁶ g/mol and in particular greater than 0.6×10⁶ g/mol. The upper limit to the weight average molecular weight of the TPU is generally determined by the processability and also the desired property spectrum. The number average molecular weight of the TPU is preferably not more than 0.8×10⁶ g/mol. The average molecular weights indicated above for the TPU and also for the formative components (a) and (b) can be determined by means of gel permeation chromatography.

As organic isocyanates (a), preference is given to using aliphatic, cycloaliphatic, araliphatic and/or aromatic isocyanates, more preferably trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane and/or 1,3-bis(isocyanatomethyl)cyclohexane (HXDI), paraphenylene 2,4-diisocyanate (PPDI), tetramethylenexylene 2,4-diisocyanate (TMXDI), dicyclohexylmethane 4,4′-, 2,4′- and 2,2′-diisocyanate (H12 MDI) hexamethylene 1,6-diisocyanate (HDI), cyclohexane 1,4-diisocyanate, 1-methycyclohexane 2,4- and/or 2,6-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethylbiphenyl diisocyanate, diphenylmethane 1,2-diisocyanate and/or phenylene diisocyanate.

Preference is given to using the isocyanates diphenylmethane 2,2′-, 2,4′- and/or 4,4′-diisocyanate (MDI), hexamethylene 1,6-diisocyanate (HDI) and dicyclohexylmethane 4,4′-, 2,4′- and 2,2′-diisocyanate (H12 MDI), with particular preference being given to diphenylmethane 4,4′-diisocyanate (4,4′-MDI).

As compounds (b) which are reactive toward isocyanates, preference is given to those having a molecular weight in the range from 500 g/mol to 8×10³ g/mol, preferably from 0.7×10³ g/mol to 6.0×10³ g/mol, in particular from 0.8×10³ g/mol to 4.0×10³ g/mol.

The compound (b) which is reactive toward isocyanate has on statistical average at least 1.8 and not more than 3.0 Zerewitinoff-active hydrogen atoms; this number is also referred to as functionality of the compound (b) which is reactive toward isocyanate and gives the theoretical molar amount, calculated for one molecule, of the isocyanate-reactive groups of the molecule. The functionality is preferably in the range from 1.8 to 2.6, more preferably in the range from 1.9 to 2.2 and in particular 2.

The compound which is reactive toward isocyanate is substantially linear and is one substance which is reactive toward isocyanate or a mixture of various substances, with the mixture then satisfying the requirement mentioned.

These long-chain compounds are used in a molar proportion of from 1 equivalent mol % to 80 equivalent mol %, based on the isocyanate group content of the polyisocyanate.

The compound (b) which is reactive toward isocyanate preferably has a reactive group selected from a hydroxyl group, an amino group, a mercapto group or a carboxyl group. Preference is given to a hydroxyl group. The compound (b) which is reactive toward isocyanate is particularly preferably selected from the group consisting of polyesterols, polyetherols and polycarbonate diols, which are also summarized under the term “polyols”.

Preference is also given to polyester diols, preferably polycaprolactone, and/or polyether polyols, preferably polyether diols, more preferably those based on ethylene oxide, propylene oxide and/or butylene oxide, preferably polypropylene glycol. One particularly preferred polyether is polytetrahydrofuran (PTHF), in particular polyetherols.

Particular preference is given to polyols selected from the following group: copolyesters based on adipic acid, succinic acid, pentanedioic acid, sebacic acid or mixtures thereof and mixtures of 1,2-ethanediol and 1,4-butanediol, copolyesters based on adipic acid, succinic acid, pentanedioic acid, sebacic acid or mixtures thereof and mixtures of 1,4-butanediol and 1,6-hexanediol, polyesters based on adipic acid, succinic acid, pentanedioic acid, sebacic acid or mixtures thereof and 3-methylpentane-1,5-diol and/or polytetramethylene glycol (polytetrahydrofuran, PTHF).

Particular preference is given to using the copolyester based on adipic acid and mixtures of 1,2-ethanediol and 1,4-butanediol or the copolyester based on adipic acid and 1,4-butanediol and 1,6-hexanediol or the polyester based on adipic acid and polytetramethylene glycol (polytetrahydrofuran PTHF) or a mixture thereof.

Very particularly preference is given to using a polyester based on adipic acid and polytetramethylene glycol (PTHF) or mixtures thereof as polyol.

In preferred embodiments, use is made of chain extenders (c); these are preferably aliphatic, araliphatic, aromatic and/or cycloaliphatic compounds which have a molecular weight of from 50 g/mol to 499 g/mol and preferably have 2 isocyanate-reactive groups, also referred to as functional groups.

The chain extender (c) is preferably at least one chain extender selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Chain extenders selected from the group consisting of 1,2-ethylene glycol, 1,3-propanediol, 1,4-butanediol and 1,6-hexanediol are particularly suitable.

Very particularly preferred chain extenders are 1,4-butanediol, 1,6-hexanediol and ethanediol.

In preferred embodiments, catalysts (d) are used together with the formative components. These are, in particular, catalysts which accelerate the reaction between the NCO groups of the isocyanates (a) and the hydroxyl groups of the compound (b) which is reactive toward isocyanates and, if used, the chain extender (c). Preferred catalysts are tertiary amines, in particular triethylamine, dimethylcyclohexylamine, N-methylmorpholine, N,N′-dimethylpiperazine, 2-(dimethylaminoethoxy)ethanol, diazabicyclo[2.2.2]octane. In another preferred embodiment, the catalysts are organic metal compounds such as titanic esters, iron compounds, preferably iron(III) acetylacetonate, tin compounds, preferably those of carboxylic acids, particularly preferably tin diacetate, tin dioctoate, tin dilaurate or dialkyltin salts, more preferably dibutyltin diacetate, dibutyltin dilaurate, or bismuth salts of carboxylic acids, preferably bismuth decanoate.

Particularly preferred catalysts are tin dioctoate, bismuth decanoate, titanic esters. The catalyst (d) is preferably used in amounts of from 0.0001 to 0.1 part by weight, from 0.001 to 0.05 part by weight per 100 parts by weight of the isocyanate-reactive compound (b).

Apart from catalysts (d), customary auxiliaries (e) can also be added to the formative components (a) to (c). Mention may be made by way of example of surface-active substances, fillers, flame retardants, nucleating agents, oxidation inhibitors, lubricants and mold release agents, dyes and pigments, optionally stabilizers, preferably against hydrolysis, light, heat or discoloration, inorganic and/or organic fillers and/or plasticizers.

In an embodiment, the TPU is brought into contact with the blowing agent.

In principle, the expanded TPU pellets can be produced via suspension or extrusion processes directly or indirectly by way of expandable TPU pellets and foaming in a pressure prefoamer with steam or hot air.

In the suspension process, the TPU in the form of pellets is heated with water, with a suspending agent, and with the blowing agent in a closed reactor to above the softening point of the pellets. The polymer pellets are thereby impregnated by the blowing agent. It is then possible either to cool the hot suspension, whereupon the particles solidify with inclusion of the blowing agent, and to depressurize the reactor. The (expandable) pellets comprising blowing agent and obtained in this way are foamed via heating to give the expanded pellets. As an alternative, it is possible to depressurize the hot suspension suddenly, without cooling (explosion-expansion process), whereupon the softened pellets comprising blowing agent immediately foam to give the expanded pellets.

In the extrusion process, the TPU is mixed, with melting, in an extruder with a blowing agent which is introduced into the extruder. Either the mixture comprising blowing agent is extruded and pelletized under conditions of pressure and temperature such that the TPU pellets do not foam (expand), an example of a method being used for this purpose being underwater pelletization, which is operated with a water pressure of more than 2 bar. This gives expandable pellets comprising blowing agent, which are then foamed via subsequent heating to give the expanded pellets. Or the mixture can also be extruded and pelletized at atmospheric pressure. In this process, the melt extrudate foams and the product obtained via pelletization is the expanded pellets.

The TPU can be used in the form of commercially available pellets, powder, granules, or in any other form. It is advantageous to use pellets. An example of a suitable form is what are known as pellets whose preferred average diameter is from 0.2 to 10 mm, in particular from 0.5 to 5 mm. These mostly cylindrical or round pellets are produced via extrusion of the TPU and, if appropriate, of other additives, discharged from the extruder, and if appropriate cooling, and pelletization. In the case of cylindrical pellets, the length is preferably from 0.2 to 10 mm, in particular from 0.5 to 5 mm. The pellets can also have a lamellar shape. The average diameter of the thermoplastic polyurethane comprising blowing agent is preferably from 0.2 to 10 mm.

As a function of the process used, the preferred blowing agents can vary if appropriate. In the case of the suspension process, the blowing agent used preferably comprises organic liquids or inorganic gases, or a mixture thereof. Liquids that can be used comprise halogenated hydrocarbons, but preference is given to saturated, aliphatic hydrocarbons, in particular those having from 3 to 8 carbon atoms. Suitable inorganic gases are nitrogen, air, ammonia, or carbon dioxide.

In production via an extrusion process, the blowing agent used preferably comprises volatile organic compounds whose boiling point at atmospheric pressure of 1013 mbar is from −25 to 150° C., in particular from −10 to 125° C. Hydrocarbons (preferably halogen-free) have good suitability, in particular C₄₋₁₀-alkanes, for example the isomers of butane, of pentane, of hexane, of heptane, and of octane, particularly preferably sec-pentane. Other suitable blowing agents are bulkier compounds, examples being alcohols, ketones, esters, ethers, and organic carbonates.

It is also possible to use halogenated hydrocarbons, but the blowing agent is preferably halogen-free. Very small proportions of halogen-containing blowing agents in the blowing agent mixture are however not to be excluded. It is, of course, also possible to use mixtures of the blowing agents mentioned.

The amount of blowing agent is preferably from 0.1 to 40 parts by weight, in particular from 0.5 to 35 parts by weight, and particularly preferably from 1 to 30 parts by weight, based on 100 parts by weight of TPU used.

If the expandable TPU pellets are obtained, these can be foamed in a known manner to obtain the expanded TPU pellets. The foaming generally takes place via heating of the expandable pellets in conventional foaming apparatuses, e.g., with hot air or superheated steam in what is known as a pressure prefoamer, for example of the type usually used for processing of expandable polystyrene (EPS). It is preferable to foam the pellets at a temperature at which they soften (softening range), particularly preferably at temperatures of from 100 to 140° C.

The bulk densities of expanded TPU pellets can be from 10 to 600 g/l, and preferably from 15 to 300 g/l.

The average diameters of the expanded TPU pellets are usually in the range from 0.2 to 20 mm, preferably from 0.5 to 15 mm, and in particular from 1 to 12 mm. In the case of non-spherical, e.g., elongate or cylindrical, pellets, diameter means the longest dimension.

The TPU powders according to the present invention can be obtained by pulverizing the expanded TPU pellets and/or molding parts thereof.

In an embodiment, the expanded TPU is recycled expanded TPU, leftover expanded TPU, molding parts of the expanded TPU or mixture thereof.

The recycled expanded TPU can be shaped articles for example soles. The recycled expanded TPU can be pulverized to obtained the TPU powders according to the present invention. Before pulverization, the recycled expanded TPU can be cleaned and/or separated from the foreign materials.

The TPU powders of the present invention allows to prepare 3D molding (for example via 3D printing) with low density, high rebound resilience, preferably good mechanical properties, especially elongation at break. The details of density, rebound resilience and mechanical properties of the 3D molding are as described below for the 3D molding of the present invention.

### Composition

An aspect of the present invention relates to a powder composition comprising the TPU powders according to the present invention and at least one auxiliary agent. The auxiliary agent can be selected from filler, flowing agent and pigment.

The flowing agent can be selected from the group consisting of silica, fumed silica, precipitated silica, colloidal silica, hydrophobic/hydrophilic silica and mixtures of thereof.

The flowing agent of the invention has a median particle size of from 5 nm to 200 μm. The preferred median particle size of the flowing agent is from 10 nm to 150 μm, particularly preferably from 100 nm to 100 μm.

The flowing agent has a specific surface area of from 20 to 600 m²/g. The flowing agent preferably has a specific surface area of from 40 to 550 m²/g, particularly preferably from 60 to 500 m²/g, and more preferably from 60 to 450 m²/g.

The amount of the flowing agent in the composition can be from 0 to 5% by weight, 0.01 to 5% by weight, from 0.01 to 3% by weight, from 0.01 to 2% by weight, from 0.05 to 5% by weight, from 0.05 to 3% by weight, from 0.05 to 2% by weight, from 0.1 to 5% by weight, from 0.1 to 3% by weight, or from 0.1 to 2% by weight, based on the total weight of the composition.

Examples of fillers can include glass microsphere, glass fiber and carbon fiber.

As other auxiliary agents, mention may be made by way of preferred example of surface-active substances, nucleating agents, lubricant wax, dyes, catalyst, UV absorbers and stabilizers, e.g. against oxidation, hydrolysis, light, heat or discoloration. As hydrolysis inhibitors, preference is given to oligomeric and/or polymeric aliphatic or aromatic carbodiimides. To stabilize 3D-printed objects of the invention against aging and damaging environmental influences, stabilizers are added to system in preferred embodiments.

If the composition of the invention is exposed to thermo-oxidative damage during use, in preferred embodiments antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliaries may be found in the specialist literature, e.g., in Plastics Additive Handbook, 5th edition, H. Zweifel, ed, Hanser Publishers, Munich, 2001.

The total amount of at least one auxiliary can be in the range from 0 to 60 wt. %, preferably from 0 to 40 wt. %, from 0 to 20 wt. %, from 0 to 10 wt. %, from 0 to 5 wt. %, or from 0.01 to 60 wt. %, 0.05 to 40 wt. %, 0.1 to 20 wt. %, based on the total weight of the composition.

### Process for Preparing the 3D Molding

In a further aspect, the invention relates to a process for preparing the 3D molding, which comprises using the TPU powders according to the present invention or the composition according to the present invention.

In an embodiment, the process comprises:
a) adding the TPU powders of the present invention or the composition of the present invention to a molding mixture, and
b) producing the molding by selectively bonding the powders.

In an embodiment, the molding produced in step b) is produced by a process for the layer-by-layer build-up of three-dimensional objects by selectively bonding portions of a powder to on another. In a preferred embodiment, the selectively bonding comprises selective laser sintering, selective inhibition of the bonding of powders, multi jet fusion, high speed sintering, 3D printing, or a microwave process.

According to the present invention, the selectively bonding comprises selective laser sintering, selective inhibition of the bonding of powders, multi jet fusion, high speed sintering, 3D printing, or a microwave process, especially by 3D printing.

After step (b) was completed, the molding can be separated from the excess powders to obtain the final 3D molding.

According to the present invention, the excess powders can be reused in printing directly.

### 3D Molding

In a further aspect, the invention relates to a 3D molding formed from the TPU powders of the present invention or the composition of the present invention.

According to an embodiment, the 3D molding includes sole, outerwear, cloth, footwear, toy, mat, tire, hose, gloves and seals.

The 3D molding of the present invention has low density, high rebound resilience and preferably good mechanical properties, especially elongation at break.

In a preferred embodiment, the density of the 3D molding of the present invention is no more than 1 g/cm³, for example, 0.95 g/cm³, 0.9 g/cm³, 0.85 g/cm³, 0.8 g/cm³, 0.78 g/cm³, 0.76 g/cm³, 0.74 g/cm³, 0.72 g/cm³, 0.70 g/cm³, 0.68 g/cm³, 0.66 g/cm³, 0.64 g/cm³, 0.62 g/cm³, 0.6 g/cm³, 0.58 g/cm³, 0.56 g/cm³ or 0.55 g/cm³, preferably the density of the 3D molding of the present invention is no more than 0.95 g/cm³, no more than 0.9 g/cm³, no more than 0.8 g/cm³, 0.78 g/cm³, no more than 0.76 g/cm³, no more than 0.74 g/cm³, or no more than 0.72 g/cm³. Preferably, the density of the 3D molding of the present invention is in the range from 0.1 to 1 g/cm³, from 0.1 to 0.9 g/cm³, from 0.1 to 0.8 g/cm³, from 0.2 to 0.8 g/cm³, from 0.3 to 0.8 g/cm³, from 0.4 to 0.8 g/cm³, from 0.5 to 0.8 g/cm³, from 0.6 to 0.78 g/cm³, or from 0.62 to 0.76 g/cm³.

The density can be tested according to ASTM D792.

In a preferred embodiment, the rebound resilience according to ASTM D2632 of the 3D molding of the present invention is at least 35%, for example 36%, 38%, 40%, 42%, 45%, 48%, 50%, 52%, 55%, 58%, 60%, 62%, or 65% or 70% or 80%, preferably at least 38%, at least 40%, at least 42%, at least 45%, at least 48%. In a preferred embodiment, the rebound resilience of the 3D molding of the present invention is in the range from 35% to 80% from 35% to 70%, from 35% to 65%, from 38% to 62%, from 40% to 60%, or from 42% to 60%.

In a preferred embodiment, the elongation at break according to ISO527-21/A15 2012 of the 3D molding of the present invention is at least 50%, preferably 80%, for example 100%, 120%, 140%, 150%, 180%, 200%, 220%, 250%, 280%, 300%, 400%, 500% or 600%, preferably at least 100%, or at least 120%. In a preferred embodiment, the elongation at break of the 3D molding of the present invention is in the range from 50% to 600%, from 80% to 600%, from 80% to 550%, from 100% to 550%.

In a preferred embodiment, the hardness (Shore A) according to ASTM D2240-15 of the 3D molding of the present invention is from A 40 to A 72, for example A 44, A 46, A 48, A 50, A52, A 55, A 60, A 65, A 68, A 70 or A 72, preferably from A 44 to A 72.

The tensile strength according to ISO527-21/A15 2012 of the 3D molding of the present invention is no less than 1 MPa, for example 1.2 MPa, 1.3 MPa, 1.4 MPa, 1.5 MPa, 1.8 MPa, 2.0 MPa, 2.2 MPa, 2.5 MPa, 2.8 MPa, 3.0 MPa, 3.2 MPa, 3.5 MPa, 4 MPa, 4.5 MPa, 5 MPa, 6 MPa, 7 MPa, 8 MPa, 9 MPa, 10 MPa, 12 MPa, or 15 MPa. In a preferred embodiment, the tensile strength of the 3D molding of the present invention is in the range from 1 to 15 MPa, or from 1.2 to 12 MPa.

### Examples

### Materials

Thermoplastic Polyurethane Powders (TPU-1): Prepared by grinding of expanded TPU 130 U pellet from BASF (BASF commercial product: Infinergy X1125-130 U, bulk Density of the pellet is 0.12-0.14 g/cm³, average pellet weight is 26 mg and average pore size is 130 μm), the average particle size D50 of the powders is 160 μm, the bulk density of the powders is 0.18 g/cm³. The TPU-1 Powders were prepared by cryogenic grinding under −196° C., grinding speed 100 m/s (linear velocity) and sieved to required size.
Thermoplastic Polyurethane Powder (TPU-2): Prepared by grinding of leftover expanded TPU molding parts (as shown in FIG. 2) prepared by Infinergy 32-100 U10 (the bulk density of the pellet of Infinergy 32-100 U10 is 0.085-0.135 g/cm³ and the average pellet weight is 32 mg). The average particle size D50 of the powders is 160 μm and the bulk density of the powders is 0.23 g/cm³. The grinding procedure was similar with those for TPU-1 powders.
Thermoplastic polyurethane powder (TPU-3): Prepared by grinding of expanded TPU 130 U pellet from BASF (BASF commercial product: Infinergy X1125-130 U, the bulk Density of the pellet is 0.12-0.14 g/cm³, the average pellet weight is 26 mg, average pore size is 130 μm), the average particle size D50 of the powders is 80 μm, the bulk density of the powders is 0.25 g/cm³. The grinding procedure was similar with those for TPU-1 powders.
TPU 88A: Ultrasint TPU 88A powder for 3D printing from BASF. The TPU powder is prepared by grinding of TPU pellet. Bulk density of TPU 88A: 0.6 g/cm3, average particle size D50 of TPU 88A: 80 μm.
Flowing agent: HDKN20 amorphous silica from Wacker (BET: 175-225 m²/g), Cabot ENERSIL 2030 fumed silica (BET: 175-225 m²/g).

### Methods

All samples were printed by Farsoon HT251 SLS 3D printer.
Tensile strength and elongation at break were measured at a rate of 6 mm/min (according to ISO527-21/A15 2012) by Zwick Z050.
Rebound resilience was tested according to ASTM D2632.
Hardness was determined in accordance with ASTM D2240-15 with ASKER DUROMETER (TYPE A).
Density was investigated according to ASTM D792.
The average particle size D50 of powder was tested according to ISO 13320-1 by Beckerman Coulter LS 13 320 Lase Diffraction Particle Size Analyzeer.
The bulk density of the TPU powders was tested according to ISO1068.

### Examples A, B C, D, E and Comparative Example 1

The powders in example A and comparative example 1 as shown in table 1 were used as such.

The powder compositions in examples B, C, D and E were prepared by blending the powders of the components as shown in table 1. The blending experiments were carried out on the HTS-5 High speed mixer from Dongguan Huanxin Machinery Co., Ltd. Each component was weighted according to the weight percent as shown in table 1. The powders were mixed under 1400 rpm for 60 seconds to obtain the powder composition, the total weight of each composition was 5000 g.

TABLE 1
the weight percentage of each component

| | Example | | | | | |
|---|---|---|---|---|---|---|
| | | | | | | Comparative |
| | A | B | C | D | E | example 1 |
| TPU powders: | | | | | | 100 |
| Ultrasint TPU | | | | | | |
| 88A (wt %) | | | | | | |
| TPU-1 (wt %) | 100 | 99.5 | 99.5 | | | |
| TPU-2 (wt %) | | | | 99.2 | | |
| TPU-3 (wt %) | | | | | 99.5 | |
| EN2030 (wt %) | | 0.5 | | | | |
| N20 (wt %) | | | 0.5 | 0.8 | 0.5 | |

### Example 2—3D Printing

The powders or powder compositions of examples A, B, C, D, E and comparative example 1 were printed by HT251 Selective Laser Sintering 3D printer which was manufactured from Farsoon. For a typical printing process, the powders or powder compositions were loaded in the feed chamber of the printer. For all printing processes, the printing parameters need to be adjusted according to different type of powders and their cracking or warping phenomenon during printing process. Detailed printing parameters were listed in the table 2.

Post-treatment process: Once the printing process was completed and the printed objects were cooled, the build chamber was removed from the printer and transferred to a cleaning station, the printed objects were separated from the excess powders to obtain the final 3D-printed objects.

TABLE 2
Printing parameters for the powders or powder compositions
from examples A, B, C, D, E and comparative example 1

| | Example | | | | | |
|---|---|---|---|---|---|---|
| | | | | | | Comparative |
| | A | B | C | D | E | example 1 |
| Part bed T (° C.) | 65 | 65 | 65 | 65 | 65 | 85 |
| Feed T (° C.) | 40 | 40 | 40 | 40 | 40 | 40 |
| Piston T (° C.) | 50 | 50 | 50 | 50 | 50 | 80 |
| Cylinder T (° C.) | 50 | 50 | 50 | 50 | 50 | 80 |
| Laser power (W) | 45 | 45 | 45 | 45 | 45 | 40 |
| Outline laser power (W) | 7 | 7 | 7 | 7 | 7 | 7 |
| Laser scan spacing (mm) | 0.1 | 0.1 | 0.1 | 0.1 | 0.1 | 0.13 |
| Laser scan speed (m/s) | 7.62 | 7.62 | 7.62 | 7.62 | 7.62 | 7.62 |
| Layer thickness (mm) | 0.1 | 0.1 | 0.1 | 0.1 | 0.1 | 0.1 |
| Roller speed (mm/s) | 180 | 180 | 180 | 180 | 180 | 223 |
| Laser fill count | 2 | 2 | 2 | 2 | 2 | 1 |

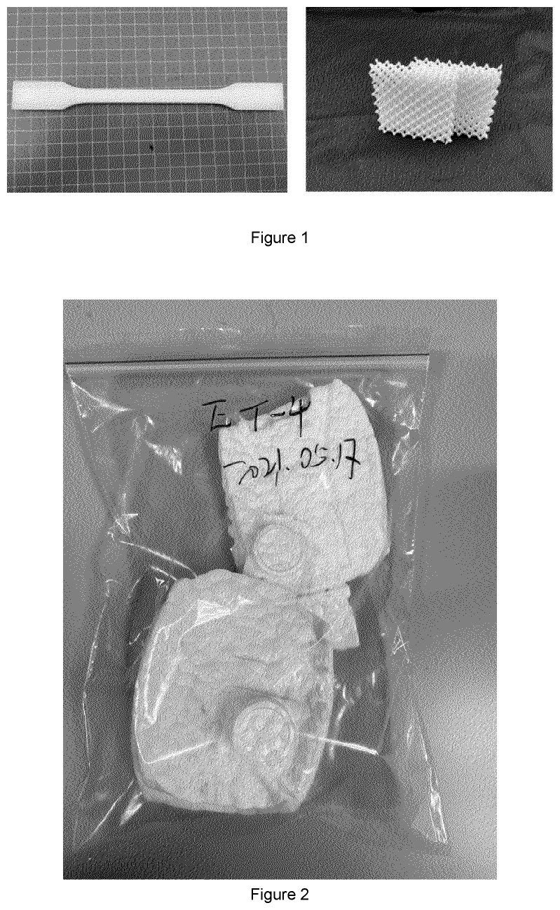

Pictures of printed samples prepared from the powder composition of example C were shown in FIG. 1.

Tensile strength, elongation at break, hardness, rebound resilience and density of the printed samples were summarized in table 3.

TABLE 3

| | Example | | | | | |
|---|---|---|---|---|---|---|
| | | | | | | Comparative |
| | A | B | C | D | E | example 1 |
| Tensile Strength (MPa) | 2.0 | 1.5 | 2.8 | >7.4 | >10 | 8 |
| Elongation at break (%) | 175 | 146 | 220 | >470%* | >470% | 270 |
| Hardness (Shore A) | 61 | 48 | 50 | 63 | 70 | 88 |
| Rebound resilience (%) | 50 | 48 | 56 | 54 | 49 | 28 |
| Density (g/m³) | 0.724 | 0.695 | 0.663 | 0.600 | 0.713 | 1.1 |

*The elongation at break for the samples of examples D and E were out of the measure range.

Printed samples based on the powders from expanded TPU or molding parts thereof (examples A, B, C, D and E) exhibited significant low density and high rebound resilience comparing with those of the printed samples based on the powders from TPU (comparative example 1).

1.-18. (canceled)

19. Thermoplastic polyurethane (TPU) powders derived from expanded TPU and/or molding part thereof, wherein the powders have an average particle size D50 of no more than 1 mm.

20. The TPU powders according to claim 19, wherein the average particle size D50 of the TPU powders is in the range from 1 μm to 1 mm.

21. The TPU powders according to claim 19, wherein the average particle size D50 of the TPU powders is in the range from 5 to 800 μm.

22. The TPU powders according to claim 19, wherein the bulk density of the TPU powders is no more than 1 g/cm³.

23. The TPU powders according to claim 19, wherein the TPU powders are derived from expanded TPU pellets or molding part thereof or leftover expanded TPU or recycled expanded TPU, or mixture thereof.

24. Use of expanded TPU and/or molding part thereof for manufacturing the TPU powders according to claim 19.

25. A process of preparing the TPU powders according to claim 19, which comprises pulverizing expanded TPU and/or molding part thereof.

26. A powder composition comprising the TPU powders according to claim 19 and at least one auxiliary agent.

27. Use of the TPU powders according to claim 19 for preparing the 3D molding.

28. A process for preparing the 3D molding, which comprises using the TPU powders according to claim 19.

29. The process according to claim 28, wherein the process comprises:
a) adding the TPU powders a to a molding mixture, and
b) producing the molding by selectively bonding the powders.

30. The process according to claim 29, wherein the molding produced in step b) is produced by a process for the layer-by-layer build-up of three-dimensional objects by selectively bonding portions of a powder to on another.

31. The process according to claim 29, wherein the selectively bonding comprises selective laser sintering, selective inhibition of the bonding of powders, multi jet fusion, high speed sintering, 3D printing, or a microwave process.

32. A 3D molding formed from the TPU powders according to claim 19.

33. The 3D molding according to claim 32, wherein the 3D molding includes sole, outerwear, cloth, footwear, toy, mat, tire, hose, gloves and seals.

34. The 3D molding according to claim 32, wherein the density of the 3D molding is no more than 1 g/cm³.

35. The 3D molding according to claim 32, wherein the rebound resilience according to ASTM D2632 of the 3D molding is at least 35%.

36. The 3D molding according to claim 32, wherein the elongation at break according to ISO527-21/A15 2012 of the 3D molding is at least 50%.
